(19) United States
(12) Patent Application Publication
(10) Pub. No.: US 2004/0183784 A1
(43) Pub. Date: Sep. 23, 2004

(54) Keyboard either cable connected or wireless

(76) Inventors: Cheana Chang, Hsin Chuang City (TW); Chung Yuan Cheng, Hsin Chuang City (TW)

Correspondence Address: Cheana Chang, P.O. Box 4-67, Hsin Chuang, Taipei, 242, TW

(21) Appl. No.: 10/394,541

(22) Filed: Mar. 19, 2003

(51) Int. Cl. G09G 5/00

(52) U.S. Cl. 345/168

(57) ABSTRACT

A blue tooth keyboard includes a blue tooth processor device, a USB control device for connecting to computer facilities via a USB interface device, a keyboard matrix device and a keyboard control device coupled to the blue tooth processor device and the USB control device, to detect and to selectively send signals of the blue tooth keyboard to either the blue tooth processor device or the USB control device. The signals of the blue tooth keyboard may be sent to the computer facilities wirelessly or via various interface cards.

### BACKGROUND OF THE INVENTION

1. Field of the Invention

The present invention relates to a keyboard, and more particularly to a blue tooth keyboard that is selectively cable connectable or workable wirelessly.

2. Description of the Prior Art Various kinds of typical computer keyboards have been developed and widely used for coupling to computer facilities, in order to control or to operate the computer facilities and/or the peripheral facilities thereof.

However, the typical computer keyboards are required to be coupled to computer facilities with electric wires or cables, and may not be easily carried with the users, and thus may not be effectively used or coupled to computer facilities to control or to operate the computer facilities and/or the peripheral facilities thereof outdoors.

The present invention has arisen to mitigate and/or obviate the afore-described disadvantages of the conventional keyboards.

### SUMMARY OF THE INVENTION

The primary objective of the present invention is to provide a blue tooth keyboard that may be selectively cable connectable or workable wirelessly.

In accordance with one aspect of the invention, there is provided a blue tooth keyboard comprising a blue tooth processor device, a USB interface device for connecting to computer facilities, USB control device coupled to the USB interface device, a moving route selecting device coupled between the blue tooth processor device and the USB control device, a keyboard matrix device and a keyboard control device coupled to the moving route selecting device, to detect and to selectively send signals of the blue tooth keyboard to either the blue tooth processor device or the USB control device via the moving route selecting device, and a signal transmitting device coupled to the blue tooth processor device, to transmit the signals of the blue tooth keyboard from the blue tooth processor device out to computer facilities.

An electric power supply device may further be provided and coupled between the blue tooth processor device and the keyboard control device, to supply electric energy to energize the blue tooth processor device.

A resetting device may further be provided and coupled between the electric power supply device and the blue tooth processor device to reset the blue tooth processor device.

An electric power supply device may further be provided and coupled between the USB control device and the USB interface device, to supply electric energy to energize the USB control device.

A moving route switching device may further be provided and coupled between the blue tooth processor device and the electric power supply device, to control the blue tooth processor device by the electric power supply device.

An electric power switching device may further be provided and coupled to the electric power supply device, and a battery coupled to the electric power switching device, to charge the battery via the electric power supply device and the electric power switching device.

An electric power interface device may further be provided and coupled between the electric power switching device and the battery, to protect the battery.

A charging device may further be provided and coupled between the electric power switching device and the electric power interface device, to control the charge of the battery.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating the elements or members of a blue tooth keyboard in accordance with the present invention;

FIG. 2 is a plan schematic view similar to FIG. 1, illustrating the wireless operation of the blue tooth keyboard; and

FIG. 3 is a plan schematic view similar to FIGS. 1 and 2, illustrating the cable connected operation of the blue tooth keyboard.

### DETAILED DESCRIPTION OF THE PREFERRED EMBODIMENT

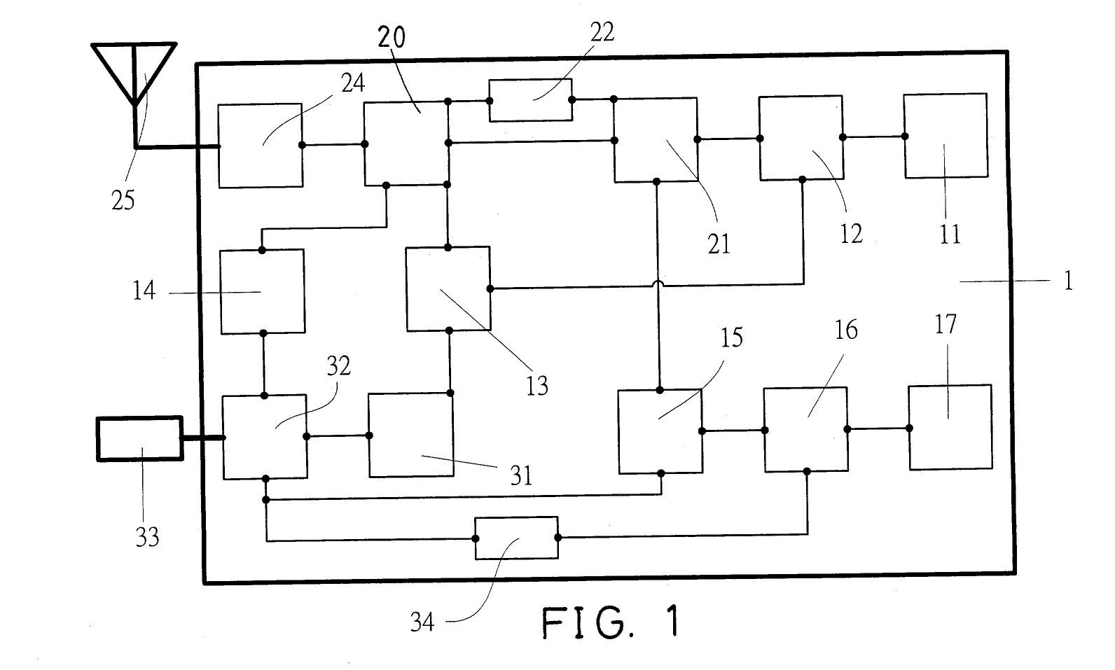

Referring to the drawings, and initially to FIG. 1, a keyboard in accordance with the present invention is a blue tooth keyboard 1 and comprises a blue tooth control chip or integrated circuit or blue tooth processor device 20, an electric power supply circuit or device 21 is coupled to the blue tooth processor device 20 for providing electric power to energize the blue tooth processor device 20 and/or the blue tooth keyboard 1.

A keyboard control circuit or device 12 is coupled to the blue tooth processor device 20 directly or indirectly via the electric power supply device 21, for detecting and sending the signals of the blue tooth keyboard 1 to the blue tooth processor device 20, and thus for allowing the blue tooth processor device 20 to receive or to control or to process the signals of the blue tooth keyboard 1.

A keyboard matrix circuit or device 11 is coupled to the blue tooth processor device 20 directly or indirectly via the keyboard control device 12 and the electric power supply device 21, for detecting and sending the signals of the blue tooth keyboard 1 to the blue tooth processor device 20, and thus for allowing the blue tooth processor device 20 to receive or to control or to process the signals of the blue tooth keyboard 1.

The keyboard control device 12 may further be indirectly coupled to the blue tooth processor device 20 via a moving path or route selecting circuit or device 13 which may provide or select the signals of the blue tooth keyboard 1 to the blue tooth processor device 20, or may transmit the signals of the blue tooth keyboard 1 from the keyboard control device 12 to the blue tooth processor device 20.

A signal transmitting circuit or device 24 is coupled to the blue tooth processor device 20, and an antenna 25 is coupled to the signal transmitting device 24, for allowing the signals of the blue tooth keyboard 1 to be transmitted out from the blue tooth processor device 20 to the computer facilities of the users, or other wirelessly operated facilities, with the wireless operation or transmission.

A resetting circuit or device 22 may further be provided and coupled between the blue tooth processor device 20 and the electric power supply device 21, in order to reset the blue tooth processor device 20, and thus to allow the blue tooth processor device 20 to be suitably or properly operated or worked, after the other working operations.

The blue tooth keyboard 1 includes a universal serial bus (USB) interface circuit or card or device 33 coupled thereto, and an electric power supply circuit or device 32 coupled to the USB interface device 33, for receiving and transmitting the signals from or to the USB interface device 33, and for providing electric power to energize the USB interface device 33 and/or the blue tooth keyboard 1. The USB interface device 33 may be coupled to the computer facilities (not shown) of the end users, for coupling the blue tooth keyboard 1 to the computer facilities of the end users.

A USB control circuit or device 31 is coupled to the USB interface device 33 directly or indirectly via the electric power supply device 32, and is coupled to the moving path or route selecting device 13, for allowing the signals of the blue tooth keyboard 1 from the keyboard control device 12 and/or from moving path or route selecting device 13 to be transmitted to the USB interface device 33 via the USB control device 31 and/or the electric power supply device 32.

It is to be noted that the moving path or route selecting device 13 may be used to select or switch or control the transmission of the signals of the blue tooth keyboard 1 either to the blue tooth processor device 20 or to the USB interface device 33 directly or indirectly via the USB control device 31 and/or the electric power supply device 32.

A moving path or route switching circuit or device 14 may further be provided and coupled between the blue tooth processor device 20 and the USB interface device 33 or the electric power supply device 32, in order to control or to switch on and off the blue tooth processor device 20, and/or to control or to switch on and off the USB interface device 33, and/or to control the electric power supply to either the blue tooth processor device 20 or the USB interface device 33.

An electric power switching circuit or device 15 is coupled between the electric power supply device 21 and the electric power supply device 32, in order to control or to switch on and off the electric power supply device 21 and the electric power supply device 32. An electric power interface circuit or device 16 may further be provided and coupled to the electric power switching device 15.

A battery, such as a chargeable battery 17 is coupled to the electric power switching device 15 directly or indirectly via the electric power interface device 16, in order to supply the electric energy to the electric power switching device 15, and then to supply the electric energy to either the electric power supply device 21 or the electric power supply device 32. The electric power interface device 16 may be used to control the charging operation of the battery 17 or to protect the battery 17.

A charging circuit or device 34 may further be provided and coupled between the electric power supply device 32 and the electric power interface device 16, in order to further control the charging operation of the battery 17 directly or indirectly via the electric power interface device 16, by the electric power supply device 32. At this moment, the electric power interface device 16 is primarily provided to protect the battery 17, from such as being overcharged.

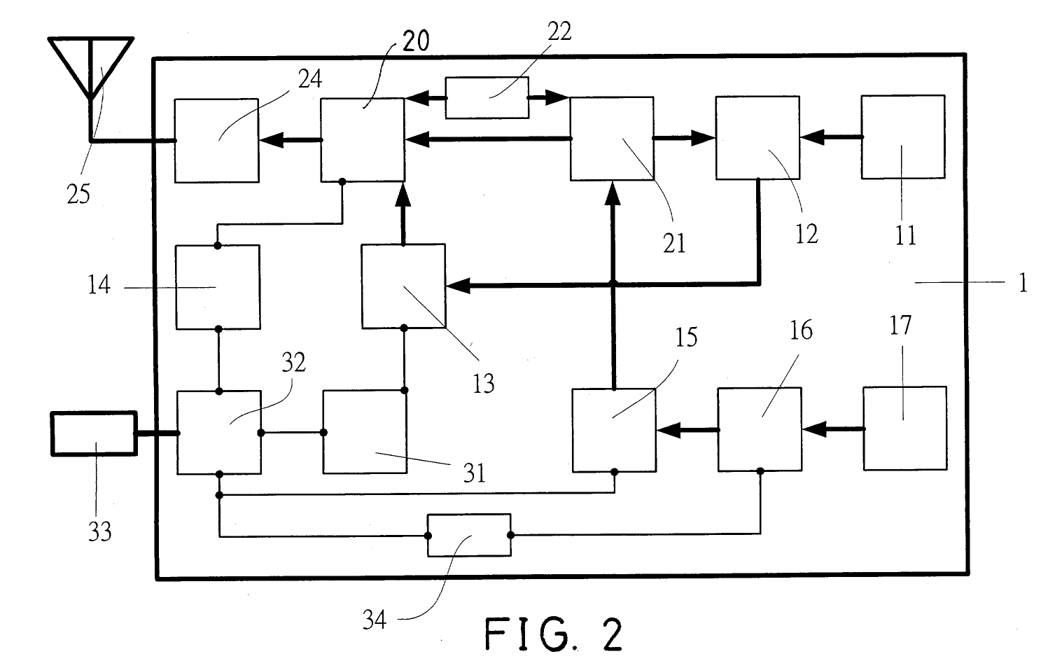

Referring next to FIG. 2, illustrated is the operation of the blue tooth keyboard 1 in a wirelessly operating mode. In operation, as shown in solid lines in FIG. 2, the battery 17 may supply the electric energy to the electric power supply device 21, in order to energize the blue tooth processor device 20 and/or the other elements or members or devices of the blue tooth keyboard 1. The laser pointer 18 may also be energized by the battery 17, for pointing or indicating purposes, and/or for controlling or operating the computer facilities and/or the peripheral facilities of the computer facilities.

The signals of the blue tooth keyboard 1 from the keyboard matrix device 11 and/or from the keyboard control device 12 may then be transmitted out from the blue tooth processor device 20 to the computer facilities of the users, or other wirelessly operated facilities, with the wireless operation or transmission, via the signal transmitting device 24 and the antenna 25. The computer facilities and/or the other peripheral facilities of the users may thus be controlled or operated with the blue tooth keyboard 1 wirelessly.

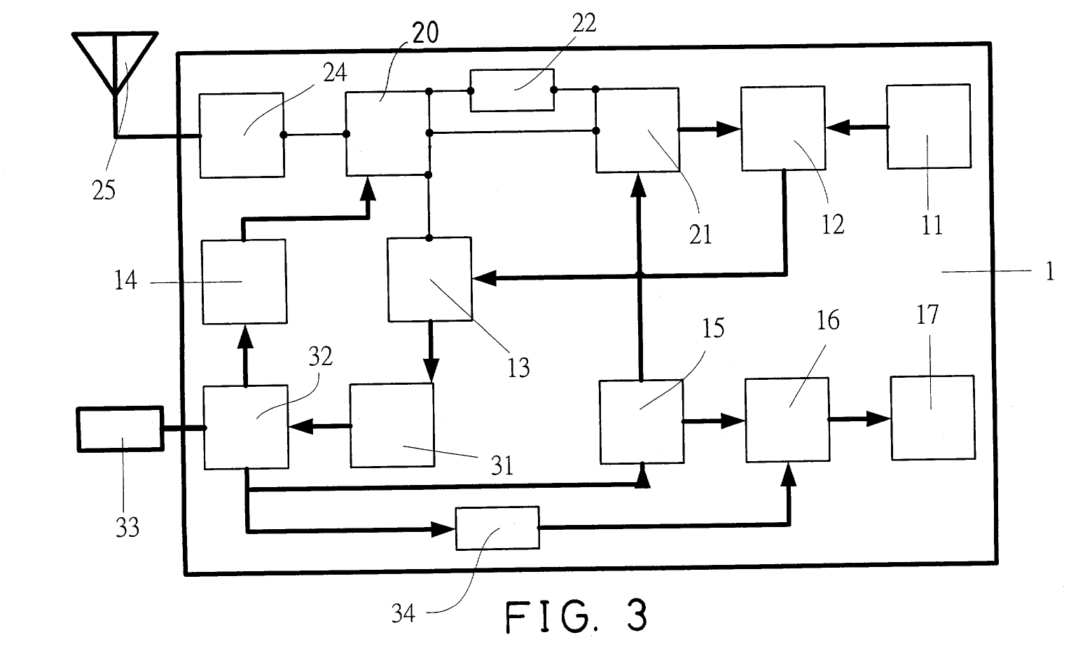

Referring next to FIG. 3, illustrated is the operation of the blue tooth keyboard 1 in a cable connected mode. In operation, as shown in solid lines in FIG. 3, the signals of the blue tooth keyboard 1 from the keyboard matrix device 11 and/or from the keyboard control device 12 may be transmitted to the computer facilities of the users via the USB interface device 33 that is cable connected to the computer facilities of the users.

The moving path or route selecting device 13 may be used to select or switch or control the transmission of the signals of the blue tooth keyboard 1 to the USB interface device 33, instead of to the blue tooth processor device 20. The USB control device 31 may receive and process or convert the signals of the blue tooth keyboard 1 into USB signals, which may then be sent to the USB interface device 33 directly or indirectly via the electric power supply device 32.

The electric power supply device 21 may also be energized or powered by the battery 17, in order to energize the keyboard matrix device 11 and the keyboard control device 12, and/or the other elements or members or devices of the blue tooth keyboard 1.

When the battery 17 is short of electric power or energy, the electric power or energy from the computer facilities of the users may be sent to the electric power supply device 21, via the USB interface device 33 and/or the electric power supply device 32, and controlled by the electric power switching device 15, in order to energize the keyboard matrix device 11 and the keyboard control device 12, and/or the other elements or members or devices of the blue tooth keyboard 1.

In addition, when the battery 17 is short of electric power or energy, the charging device 34 may be used to actuate or to control the charging operation of the battery 17 directly or indirectly via the electric power interface device 16. The laser pointer 18 may thus be energized either by the electric power supply device 21 or by the battery 17, for pointing or indicating purposes, and/or for controlling or operating the computer facilities and/or the peripheral facilities of the computer facilities.

When the electric power supply device 32 is detected to supply the electric power or energy from the computer facilities of the users to the electric power supply device 21 via or controlled by the electric power switching device 15, the moving path or route switching device 14 may switch off or cut the electric power supply to the blue tooth processor device 20, in order to stop the blue tooth processor device 20.

Accordingly, the blue tooth keyboard in accordance with the present invention may be worked or operated wirelessly, and may be selectively cable connected to the other interface cards, and may also be selectively energized via the interface cards.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A blue tooth keyboard comprising:
a blue tooth processor device,
a USB interface device for connecting to computer facilities,
a USB control device coupled to said USB interface device,
a moving route selecting device coupled between said blue tooth processor device and said USB control device,
a keyboard matrix device and a keyboard control device coupled to said moving route selecting device, to detect and to selectively send signals of said blue tooth keyboard to either said blue tooth processor device or said USB control device via said moving route selecting device, and
a signal transmitting device coupled to said blue tooth processor device, to transmit the signals of said blue tooth keyboard from said blue tooth processor device out to computer facilities.

2. The blue tooth keyboard as claimed in claim 1 further comprising an electric power supply device coupled between said blue tooth processor device and said keyboard control device, to supply electric energy to energize said blue tooth processor device.

3. The blue tooth keyboard as claimed in claim 2 further comprising a resetting device coupled between said electric power supply device and said blue tooth processor device to reset said blue tooth processor device.

4. The blue tooth keyboard as claimed in claim 1 further comprising an electric power supply device coupled between said USB control device and said USB interface device, to supply electric energy to energize said USB control device.

5. The blue tooth keyboard as claimed in claim 4 further comprising a moving route switching device coupled between said blue tooth processor device and said electric power supply device, to control said blue tooth processor device by said electric power supply device.

6. The blue tooth keyboard as claimed in claim 4 further comprising an electric power switching device coupled to said electric power supply device, and a battery coupled to said electric power switching device, to charge said battery via said electric power supply device and said electric power switching device.

7. The blue tooth keyboard as claimed in claim 6 further comprising an electric power interface device coupled between said electric power switching device and said battery, to protect said battery.

8. The blue tooth keyboard as claimed in claim 7 further comprising s charging device coupled between said electric power switching device and said electric power interface device, to control the charge of said battery.
